(19) United States
(12) Patent Application Publication
(10) Pub. No.: US 2010/0132456 A1
(43) Pub. Date: Jun. 3, 2010

(54) Fuel Sender Assembly for Vehicle

(75) Inventor: Sungwon LEE, Hwaseong-city (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/510,623

(22) Filed: Jul. 28, 2009

(30) Foreign Application Priority Data
Dec. 2, 2008 (KR) 10-2008-0121489

(51) Int. Cl. G01F 23/36

(52) U.S. Cl. 73/313

(57) ABSTRACT

A fuel sender assembly for a vehicle may include a main housing which is mounted at a reservoir cap and is provided with a boss therein, a variable resistance unit which is mounted inside the main housing and is provided with a ceramic resistance plate having a ground resistance, a contact arm unit disposed at an upper portion of the ceramic resistance plate and rotatably mounted at the boss inside the main housing, a main cover which has a penetrating hole in a corresponding position to the boss and is mounted at a front surface of the main housing, a float arm having one end which is bent and is rotatably mounted at a front surface of the main cover and the other end, and a float mounted at the other end of the float arm so as to rotate the float arm according to the residual fuel.

### CROSS-REFERENCE TO RELATED APPLICATION

The present application claims priority to Korean Patent Application No. 10-2008-0121489 filed on Dec. 2, 2008, the entire contents of which are incorporated herein for all purposes by this reference.

### BACKGROUND OF THE INVENTION

1. Field of the Invention

The present invention relates to a fuel sender assembly for a vehicle, and more particularly to a fuel sender assembly for a vehicle that is capable of precisely detecting residual fuel in a fuel tank.

2. Description of Related Art

Generally, a fuel sender assembly is employed in a vehicle for a driver to recognize a residual fuel and to refill the fuel in a timely manner. The fuel sender assembly detects the residual fuel in a fuel tank and indicates information thereof through a cluster or an indicator.

A conventional fuel sender assembly, as shown in FIG. 6, includes a variable resistance unit 10 provided with a ceramic resistance plate 11 at a reservoir cap 3 of a fuel pump 1.

Herein, a float-type fuel sender assembly where a float arm 15 connected to a float 13 is connected to the variable resistance unit 10 through a contact arm 17 is used.

The float 13 moves upwardly and downwardly according to a level of liquid surface of fuel due to buoyancy. The float arm 15 is rotated according to upward/downward movements of the float 13 and also rotates the contact arm 17.

Further, the ceramic resistance plate 11 of the variable resistance unit 10 is connected to a sensing portion 5 of the fuel pump 1 through a cable 7. The variable resistance unit 10 contacts the contact arm 17 so as to detect a change in fuel amount and outputs it as electrical resistance.

The sensing portion 5 displays a residual fuel amount remaining in the fuel tank by transmitting a signal received from the variable resistance unit 10 to a cluster of the instrument panel.

Such the float-type fuel sender assembly has an advantage that a separate structure is not required, and thereby the overall structure is simple for applying it to a vehicle.

In recent years, studies on vehicles using ethanol fuel or bio-diesel fuel among bio-energy sources have increased in correspondence with the move toward environmentally friendly and less expensive fuels.

The float-type fuel sender assembly is applied to a fuel tank of a vehicle using a bio-energy fuel as a main energy source.

However, since the ceramic resistance plate 11 is exposed to the exterior and directly contacts the fuel according to the conventional fuel sender assembly, overall durability of the vehicle is deteriorated due to corrosion occurring on the ceramic resistance plate 11 in case of an ethanol vehicle or bio-diesel vehicle.

In addition, the corrosion on the ceramic resistance plate 11 causes the contact arm 17 to lose contact resulting in that a desirable resistance value cannot be obtained, and thereby it is difficult to precisely detect the residual fuel amount, and further, the operation of the cluster is deteriorated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a fuel sender assembly for a vehicle having advantages of improving durability of the fuel sender assembly by preventing a variable resistance unit from contacting the fuel inside the fuel tank using ethanol fuel or bio-diesel fuel, and precisely detecting residual fuel in the fuel tank.

The fuel sender assembly for a vehicle which is mounted at a fuel tank using ethanol fuel or bio-diesel fuel through a fuel pump having a sensing portion and detects residual fuel in the fuel tank, may include a main housing which is mounted at a reservoir cap of the fuel pump and is provided with a boss therein, a variable resistance unit which is mounted inside the main housing and is provided with a ceramic resistance plate having a ground resistance, a contact arm unit disposed at an upper portion of the ceramic resistance plate and rotatably mounted to the boss inside the main housing, a main cover covering an upper surface of the main housing to receive the variable resistance unit and the contact arm unit therein and having a penetrating hole in a corresponding position to the boss, a retainer unit disposed on the main cover, a float arm connected to the retainer unit, wherein an end of the float arm is bent and is rotatably mounted in the boss through the retainer unit, and a float mounted at the other end of the float arm so as to rotate the float arm and the retainer unit according to an amount of the residual fuel.

A lower portion of the main housing may be rounded with a predetermined radius.

The contact arm unit may include a body having two ends, a boss mounting portion which is integrally formed at one end of the body and is rotatably coupled around the boss, a magnet mounting portion formed at the other end of the body, a brush mounting portion which is extended from a side surface of the body and is provided with a ground brush contacting the ground resistance of the variable resistance unit, and a first magnet mounted at the magnet mounting portion.

The retainer unit may include a retainer body having one end portion corresponding to the penetrating hole of the main cover, wherein the float arm is inserted in the penetrating hole through the one end portion of the retainer body such that the retainer body is rotatably along with the float arm on the upper surface of the main cover, and a connecting portion in which a second magnet is mounted, the connecting portion extending from the other end portion of the retainer body and formed at a lower portion thereof corresponding to the first magnet mounting portion of the contract arm unit.

The corresponding surfaces of the first and second magnets may have opposite poles.

The retainer body may be provided with a plurality of mounting projections along a length direction thereof so as to receive a portion of the float arm.

The ground brush may be a plurality of wires made of steel materials.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of fuel pump provided with a fuel sender assembly for vehicle according to an exemplary embodiment of the present invention.

FIG. 2 is an exploded perspective view of a fuel sender assembly for a vehicle according to an exemplary embodiment of the present invention.

FIG. 3 is a perspective view of a contact arm unit according to an exemplary embodiment of the present invention.

FIG. 4 is a cross-sectional view taken along a line A-A in FIG. 1.

FIG. 5 shows an operation state of a fuel sender assembly for a vehicle according to an exemplary embodiment of the present invention.

FIG. 6 is a perspective view of a fuel pump provided with a fuel sender assembly for a vehicle according to an exemplary embodiment of the present invention.

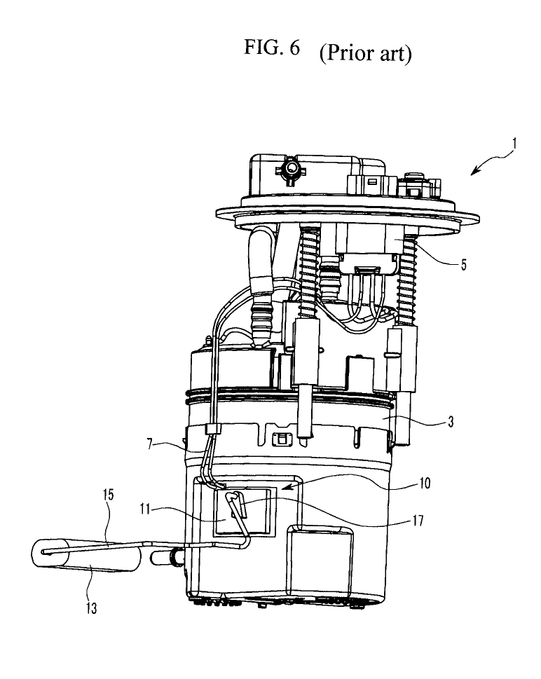

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

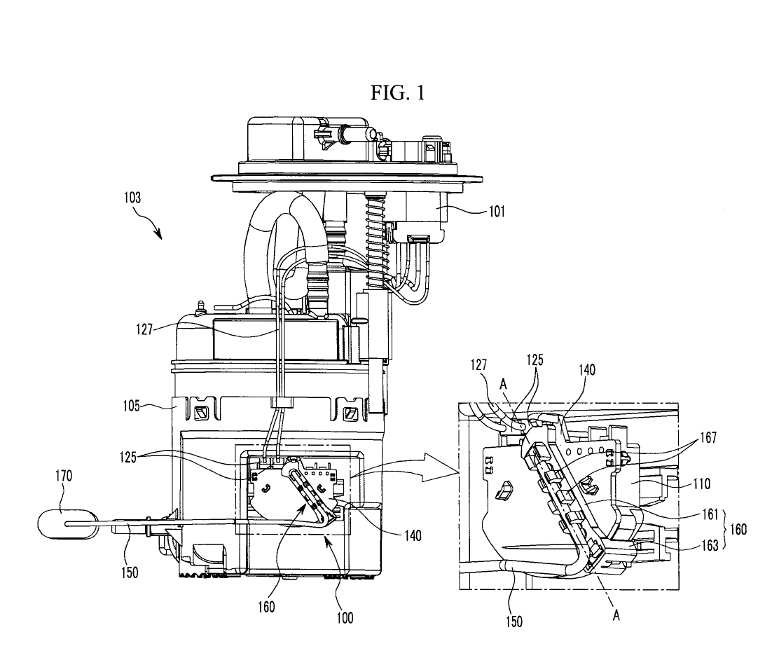

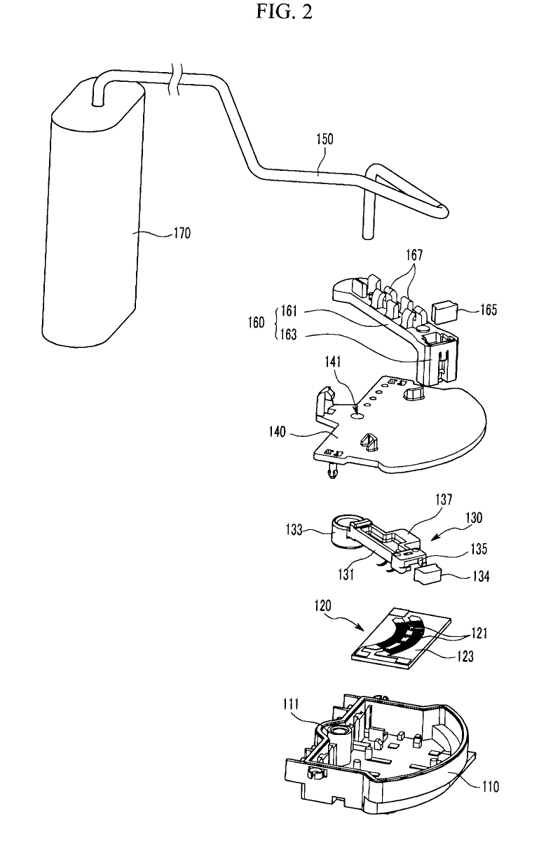

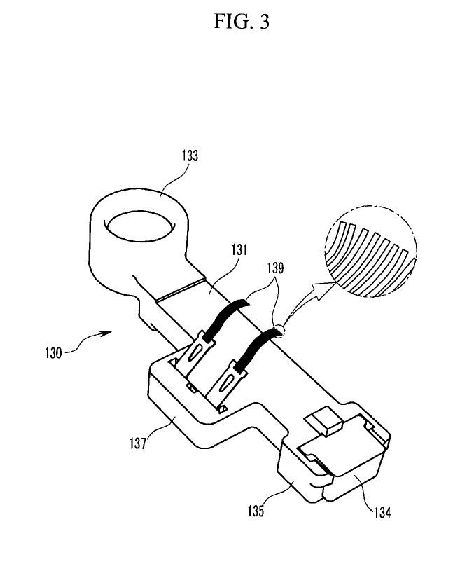

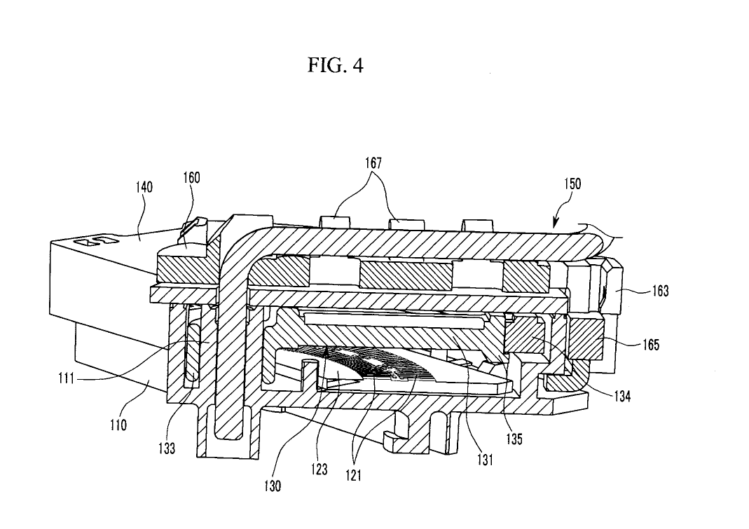

FIG. 1 is a perspective view of fuel pump provided with a fuel sender assembly for a vehicle according to an exemplary embodiment of the present invention, FIG. 2 is an exploded perspective view of a fuel sender assembly for a vehicle according to an exemplary embodiment of the present invention, FIG. 3 is a perspective view of a contact arm unit according to an exemplary embodiment of the present invention, and FIG. 4 is a cross-sectional view taken along a line A-A in FIG. 1.

As shown in FIG. 1, a fuel sender assembly 100 according to an exemplary embodiment of the present invention is mounted into a fuel tank through a fuel pump 103 having a sensing portion 101.

The fuel sender assembly 100, as shown in FIG. 2, includes a main housing 110, a variable resistance unit 120, a contact arm unit 130, a main cover 140, a float arm 150, and a float 170.

The main housing 110 is mounted at a reservoir cap 105 of the fuel pump 103.

Further, a boss 111 is formed at an upper portion inside the housing 110.

Herein, the main housing 110 may preferably be formed such that the lower portion thereof is rounded.

The variable resistance unit 120 is mounted at an inner portion of the main housing 110, and the variable resistance unit 120 includes a ceramic resistance plate 123 provided with a ground resistance 121.

Further, the variable resistance unit 120 is connected to the sensing portion 101 through a cable 127 via a connector 125 mounted at an exterior of the main housing 110.

Said cable 127 is connected to the ground resistance 121.

The contact arm unit 130 is disposed at an upper part of the ceramic resistance plate 123, and is rotatably mounted on the boss 11 inside the main housing 110.

Herein, the contact arm unit 130, as shown in FIG. 3, includes a boss mounting portion 133 which is integrally formed at one end of a body 131 and is rotatably inserted to the boss 11, and a magnet mounting portion 135 which is integrally mounted at the other end of the body 131 and is provided with a first magnet 134.

Further, a brush mounting portion 137 is extended from a lateral surface of the body 131 so as to correspond to the ground resistance 121, and two ground brushes 139 contacting the ground resistance 121 are mounted at the brush mounting portion 137.

Herein, each ground brush 139 may preferably be a plurality of wires formed of steel materials.

The main cover 140 is provided with a penetrating hole 141 at a position corresponding to the boss 11, and the main cover 140 is mounted at an upper surface of the main housing 110.

The main cover 140 prevents fuel from flowing into the main housing 110.

The float arm 150 is formed such that one end thereof is bent, and is rotatably mounted at the front of the main cover 140 through a retainer unit 160.

That is, one end of the float arm 150 is rotatably inserted into the boss 11 via the penetrating hole of the main cover 140.

Further, the float 170 is mounted at the other end of the float arm 150, and the float 170 rotates the float arm 150 with buoyancy corresponding to residual fuel in the fuel tank.

Herein, the retainer unit 160 includes a retainer body 161 and a connecting portion 163.

The retainer body 161 is rotatably mounted at the front of the main cover 140 by a float arm 150 inserted into the penetrating hole 141 of the main cover 140.

The connecting portion 163, as shown in FIG. 4, is bent such that it corresponds to the magnet mounting portion 135 of the contact arm unit 130 at a lower portion of the retainer body 161 and interposes the main housing 110 therebetween, and a second magnet 165 is mounted at the connecting portion 163.

Herein, the second magnet 165 may preferably be a negative pole about a surface facing the first magnet 134.

Specifically, when the retainer unit 160 is rotated by rotation of the float arm 150 along a lower portion of the main housing 110, an attractive force generated between the first magnet 134 and the second magnet 165 induces the contact arm unit 130 to simultaneously rotate with the retainer unit 160.

Meanwhile, a plural of mounting projections 167 are disposed along a length direction of the retainer body 161.

The float arm 150 is fixed to the retainer body 161 by the mounting projections 167.

An operation of a fuel sender assembly 100 according to an exemplary embodiment of the present invention will hereinafter be explained in detail.

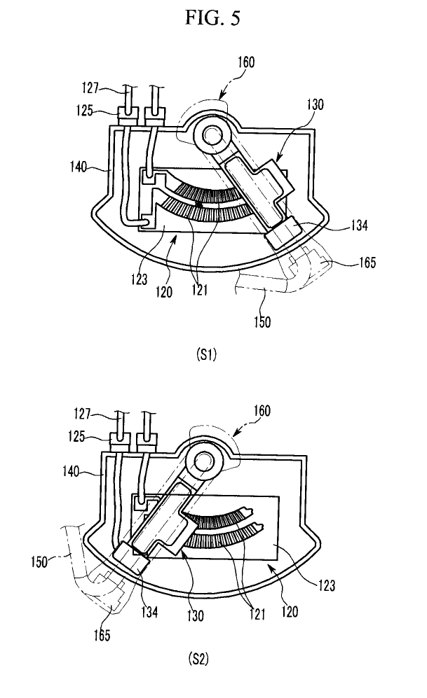

FIG. 5 shows an operation state of a fuel sender assembly for a vehicle according to an exemplary embodiment of the present invention.

Firstly, as shown in S1 and S2 of FIG. 5, buoyancy according to a height of a liquid surface in the fuel tank induces the float arm 150 connected to the float 170 upwardly and downwardly.

The connecting portion 163 of the retainer unit 160 moves along a lower portion of the main housing 110 when the retainer unit 160 rotates together with the float arm 150 at the front of the main cover 140.

At this time, the second magnet 165 exerts a magnetic force on the first magnet 134.

In this case, a surface of the first magnet 134 facing that of the second magnet 165 are opposite poles each other, so an attractive force generated therebetween induces the contact arm unit 130 to rotate together with the retainer unit 160.

That is, the contact arm unit 130 is always disposed at a same position with respect to the retainer unit 160 rotated by the float arm 150 in the main housing 110.

Herein, the ground brush 139 moves to a position of the retainer unit 160 rotated by the float arm 150 while the ground brush 139 keeps moving in such a state that it is in contact with the ground resistance 121 of the ceramic resistance plate 123.

At the same time, the ground brush 139 keeps the position as a state in which it contacts the ground resistance 121 at the position, and then a variable resistance value is transmitted to the sensing portion 101 via the cable 127.

The sensing portion 101 transmits the variable resistance value received from the variable resistance unit 120 to an ECU, and then the ECU displays the amount of residual fuel through the cluster.

As can be seen from the foregoing, a fuel sender assembly 100 according to an exemplary embodiment of the present invention can prevent fuel from flowing into the variable resistance unit 120 through the main cover 140.

Further, a position of the float 170 moving according to a height of liquid surface is transmitted to the retainer unit 160 through rotation of the float arm 150.

In this case, the retainer unit 160 rotated together with the float arm 150 maintains the position of the contact arm unit 130 to be the same as the position of the retainer unit 160 in the main housing 110 due to an attractive force generated between the first magnet 134 and the second magnet 165.

Therefore, the residual fuel can be precisely detected through a variable resistance value that is detected by a contact between the ground brush 139 and the ground resistance 121 by the contact arm unit 130 moving according to the float 170.

Further, a fuel sender assembly 101 according to an exemplary embodiment of the present invention prevents the corrosion of ceramic because it prevents the variable resistance unit 120 from contacting the fuel via the main cover 140 in the fuel tank using ethanol fuel or bio-diesel fuel, and thereby durability of the fuel sender assembly 100 can be improved.

Additionally, the fuel sender assembly 100 can precisely display a detected amount of residual fuel by means of the cluster by maintaining a position of the contact arm unit 130 in the main housing 110 to meet a position of the retainer unit 160 with an attractive force generated between the first magnet 134 and the second magnet 165.

For convenience in explanation and accurate definition in the appended claims, the terms “upper”, “downward”, “lower”, “inner”, and “upward” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel sender assembly for a vehicle which is mounted at a fuel tank using ethanol fuel or bio-diesel fuel through a fuel pump having a sensing portion and detects residual fuel in the fuel tank, comprising:
a main housing which is mounted at a reservoir cap of the fuel pump and is provided with a boss therein;
a variable resistance unit which is mounted inside the main housing and is provided with a ceramic resistance plate having a ground resistance;
a contact arm unit disposed at an upper portion of the ceramic resistance plate and rotatably mounted to the boss inside the main housing;
a main cover covering an upper surface of the main housing to receive the variable resistance unit and the contact arm unit therein and having a penetrating hole in a corresponding position to the boss;
a retainer unit disposed on the main cover;
a float arm connected to the retainer unit, wherein an end of the float arm is bent and is rotatably mounted in the boss through the retainer unit; and
a float mounted at the other end of the float arm so as to rotate the float arm and the retainer unit according to an amount of the residual fuel.

2. The fuel sender assembly of claim 1, wherein a lower portion of the main housing is rounded with a predetermined radius.

3. The fuel sender assembly of claim 1, wherein the contact arm unit comprises:
a body having two ends;
a boss mounting portion which is integrally formed at one end of the body and is rotatably coupled around the boss;
a magnet mounting portion formed at the other end of the body;
a brush mounting portion which is extended from a side surface of the body and is provided with a ground brush contacting the ground resistance of the variable resistance unit; and
a first magnet mounted at the magnet mounting portion.

4. The fuel sender assembly of claim 3, wherein the retainer unit comprises:
a retainer body having one end portion corresponding to the penetrating hole of the main cover, wherein the float arm is inserted in the penetrating hole through the one end portion of the retainer body such that the retainer body is rotatably along with the float arm on the upper surface of the main cover; and
a connecting portion in which a second magnet is mounted, the connecting portion extending from the other end portion of the retainer body and formed at a lower portion thereof corresponding to the first magnet mounting portion of the contract arm unit.

5. The fuel sender assembly of claim 4, wherein corresponding surfaces of the first and second magnets have opposite poles.

6. The fuel sender assembly of claim 4, wherein the retainer body is provided with a plurality of mounting projections along a length direction thereof so as to receive a portion of the float arm.

7. The fuel sender assembly of claim 3, wherein the ground brush is a plurality of wires made of steel materials.
